(19) United States
(12) Patent Application Publication
(10) Pub. No.: US 2021/0357558 A1
(43) Pub. Date: Nov. 18, 2021

(54) THERMAL FLUID ANALYSIS METHOD, THERMAL FLUID ANALYSIS DEVICE, CONVERSION METHOD, CONVERSION DEVICE, AND RECORDING MEDIUM

(71) Applicant: Panasonic Intellectual Property Management Co., Ltd., Osaka (JP)

(72) Inventors: Hideaki HORIO, Osaka (JP); Hiroko YOSHIDA, Osaka (JP); Norihiko EGAMI, Osaka (JP)

(21) Appl. No.: 17/284,938

(22) PCT Filed: Oct. 23, 2019
(86) PCT No.: PCT/JP2019/041429

§ 371 Date: Apr. 13, 2021

(30) Foreign Application Priority Data
Oct. 26, 2018 (JP) 2018-202016

(51) Int. Cl. G06F 30/28; F24F 11/63

(52) U.S. Cl. CPC G06F 30/28; G06F 2111/10; F24F 11/63

(57) ABSTRACT

A thermal fluid analysis method includes: calculating volumes of air blown out of blowout holes using a physical model; setting at least one virtual blowout hole corresponding to a mesh of a two-dimensional model of a space to be cooled; allotting one or more of the blowout holes to each of the at least one virtual blowout hole; calculating an equivalent volume of air blown out of the at least one virtual blowout hole based on the volumes of the air blown out of the one or more blowout holes; and setting, as an analysis parameter of the two-dimensional model, a physical amount related to the equivalent volume.

### TECHNICAL FIELD

The present invention relates to a thermal fluid analysis method, a thermal fluid analysis device, a conversion method, a conversion device, and a program.

### BACKGROUND ART

In thermal designing of products in a most suitable temperature or velocity distribution in the spaces around the products, simulation using a three-dimensional model or a two-dimensional model is often employed from the planning stage of the products in order to improve the design efficiency and reduce reworking. For example, Patent Literature (PTL) 1 discloses a product development support method through simulation using a three-dimensional model.

### CITATION LIST

### Patent Literature

[PTL 1] Japanese Unexamined Patent Application Publication No. 2000-348214

### SUMMARY OF INVENTION

### Technical Problem

In the thermal designing or other processing of a product, however, assume that a solid three-dimensional model, for example, is created as in PTL 1 described above with respect to all the parts related to the thermal designing of the product to analyze a thermal fluid. In this case, designing the three-dimensional model, for example, and calculation using the three-dimensional model take time, which makes it difficult to efficiently analyze the thermal fluid.

The present invention provides a thermal fluid analysis method, for example, of efficiently analyzing a thermal fluid.

### Solutions to Problem

A thermal fluid analysis method according to an aspect of the present invention is a method of analyzing at least one of a temperature distribution or a velocity distribution in a space to which air is blown out of a plurality of blowout holes, using a two-dimensional model or a three-dimensional model. The thermal fluid analysis method includes: calculating volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass; setting at least one virtual blowout hole corresponding to a mesh of the two-dimensional model or the three-dimensional model of the space; allotting one or more blowout holes out of the plurality of blowout holes to each of the at least one virtual blowout hole; calculating an equivalent volume of air blown out of the at least one virtual blowout hole based on the volumes of the air blown out of the one or more blowout holes; and setting, as an analysis parameter of the two-dimensional model or the three-dimensional model, a physical amount related to the equivalent volume.

A program according to an aspect of the present invention is for causing a computer to execute the thermal fluid analysis method described above.

A thermal fluid analysis device according to an aspect of the present invention is for analyzing at least one of a temperature distribution or a velocity distribution in a space to which air is blown out of a plurality of blowout holes, using a two-dimensional model or a three-dimensional model. The thermal fluid analysis device includes: a first calculator that calculates volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass; a first setter that sets at least one virtual blowout hole corresponding to a mesh of the two-dimensional model or the three-dimensional model of the space; an allotter that allots one or more blowout holes out of the plurality of blowout holes to each of the at least one virtual blowout hole; a second calculator that calculates an equivalent volume of air blown out of the at least one virtual blowout hole based on the volumes of the air blown out of the one or more blowout holes; and a second setter that sets, as an analysis parameter of the two-dimensional model or the three-dimensional model, a physical amount related to the equivalent volume.

A conversion method according to an aspect of the present invention is a method of converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass. The conversion method includes: allotting one or more blowout holes out of the plurality of blowout holes to each of at least one virtual blowout hole corresponding to a mesh of the two-dimensional model or the three-dimensional model of the space; calculating an equivalent volume of air blown out of the at least one virtual blowout hole based on volumes of the air blown out of the one or more blowout holes calculated using the physical model; and setting, as the analysis parameter of the two-dimensional model or the three-dimensional model, a physical amount related to the equivalent volume.

A program according to an aspect of the present invention is for causing a computer to execute the conversion method described above.

A conversion device according to an aspect of the present invention is for converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass. The conversion device includes: an allotter that allots one or more blowout holes out of the plurality of blowout holes to each of at least one virtual blowout hole corresponding to a mesh of the two-dimensional model or the three-dimensional model of the space; a calculator that calculates an equivalent volume of air blown out of the at least one virtual blowout hole based on volumes of the air blown out of the one or more blowout holes calculated using the physical model; and a setter that sets, as the analysis parameter of the two-dimensional model or the three-dimensional model, a physical amount related to the equivalent volume.

A thermal fluid analysis device according to an aspect of the present invention is for analyzing at least one of a temperature distribution or a velocity distribution in a space to which air is blown out of a plurality of blowout holes, using a two-dimensional model or a three-dimensional model. The thermal fluid analysis device includes: a processor; and a memory. Using the memory, the processor: calculates volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass; sets at least one virtual blowout hole corresponding to a mesh of the two-dimensional model or the three-dimensional model of the space; allots one or more blowout holes out of the plurality of blowout holes to each of the at least one virtual blowout hole; calculates an equivalent volume of air blown out of the at least one virtual blowout hole based on the volumes of the air blown out of the one or more blowout holes; and sets, as an analysis parameter of the two-dimensional model or the three-dimensional model, a physical amount related to the equivalent volume.

A conversion device according to an aspect of the present invention is for converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass. The conversion device includes: a processor; and a memory. Using the memory, the processor: allots one or more blowout holes out of the plurality of blowout holes to each of at least one virtual blowout hole corresponding to a mesh of the two-dimensional model or the three-dimensional model of the space; calculates an equivalent volume of air blown out of the at least one virtual blowout hole based on volumes of the air blown out of the one or more blowout holes calculated using the physical model; and sets, as the analysis parameter of the two-dimensional model or the three-dimensional model, a physical amount related to the equivalent volume.

### Advantageous Effects of Invention

A thermal fluid analysis method, for example, according to an aspect of the present invention allows efficient analysis of a thermal fluid.

### BRIEF DESCRIPTION OF DRAWINGS

FIG. 1 is a schematic cross-sectional view of a display case according to an embodiment.

FIG. 2 is a configuration diagram of a thermal fluid analysis device according to the embodiment.

FIG. 3 shows an example of a space to be cooled which is represented by a two-dimensional model according to the embodiment.

FIG. 4 is a flowchart showing an example of the operation of the thermal fluid analysis device according to the embodiment.

FIG. 5 illustrates a detailed operation of the thermal fluid analysis device according to the embodiment.

FIG. 6 shows an example of a GUI of the thermal fluid analysis device according to the embodiment.

FIG. 7 shows another example of the GUI of the thermal fluid analysis device according to the embodiment.

FIG. 8 shows a further another example of the GUI of the thermal fluid analysis device according to the embodiment.

FIG. 9 is a configuration diagram of a thermal fluid analysis system according to another embodiment.

FIG. 10 is a sequence diagram showing an example of the operation of the thermal fluid analysis system according to the other embodiment.

### DESCRIPTION OF EMBODIMENTS

Now, embodiments will be described with reference to the drawings. Note that the embodiments described below are mere comprehensive or specific examples of the present invention. The numerical values, shapes, materials, constituent elements, the arrangement and connection of the constituent elements, steps, step orders etc. shown in the following embodiments are thus mere examples, and are not intended to limit the scope of the present invention. Among the constituent elements in the following embodiments, those not recited in any of the independent claims defining the broadest concept are described as optional constituent elements.

The figures are schematic representations and not necessarily drawn strictly to scale. In the figures, substantially the same constituent elements are assigned with the same reference marks, and redundant descriptions may be omitted or simplified.

### Embodiment

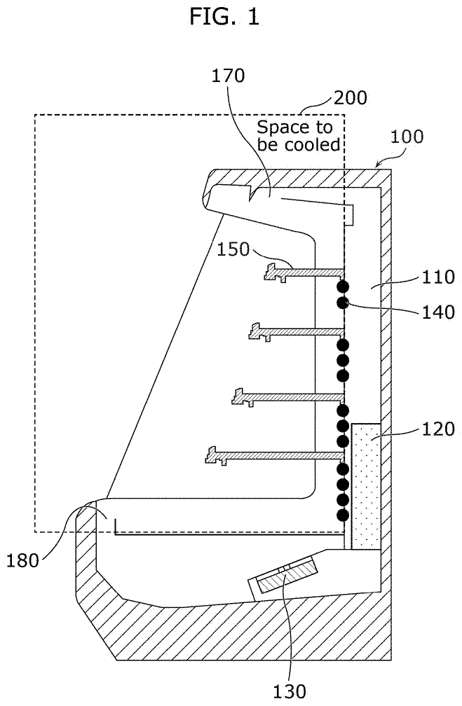

First, a product to which thermal fluid analysis device 1 according to an embodiment is applied will be described with reference to FIG. 1.

FIG. 1 is a schematic cross-sectional view of display case 100 according to the embodiment.

For thermal designing of a product, thermal fluid analysis device 1 analyzes at least one of the temperature distribution or the velocity distribution in a specific space using a two-dimensional model or a three-dimensional model. Note that thermal fluid analysis device 1 uses, as a feature, not only the two-dimensional model or the three-dimensional model but also a physical model when analyzing at least one of the temperature distribution or the velocity distribution in the specific space. In this embodiment, thermal fluid analysis device 1 is applied to a food display case (hereinafter referred to as “display case 100”) placed for cooling food, for example, in a supermarket, a convenience store, or other places. For thermal designing of display case 100, thermal fluid analysis device 1 analyzes the temperature distribution around the space to be cooled (referred to as “space 200 to be cooled”) by display case 100 using a two-dimensional model. Note that thermal fluid analysis device 1 can also analyze the velocity distribution as well as the temperature distribution, but description of the velocity distribution will be omitted below. With respect to display case 100, the temperature distribution basically has the same or similar tendency in any cross section of space 200 as viewed from the front of the paper of FIG. 1. The results of two-dimensional analysis are handled conveniently (e.g., there is no need to rotate viewpoints as in the results of three-dimensional analysis). For this reason, for example, a two-dimensional model will be focused on below and the description of a three-dimensional model will be omitted. Note that thermal fluid analysis device 1 may be used for thermal designing of not only display case 100 but also a room air conditioner, a car air conditioner, a refrigerator, or other appliances.

In order to cool the section of space 200 including food, display case 100 includes pipe 110, heat exchanger 120, fan 130, a plurality of blowout holes 140, a plurality of shelves 150, top outlet 170, and inlet 180. For example, food is placed on shelves 150. For example, as shown in FIG. 1, top outlet 170 or blowout holes 140 are arranged above or between shelves 150. The cooled air is blown out of top outlet 170 and blowout holes 140. Here, blowout holes 140 are schematically represented by black circles. Each blowout hole 140 is an elongated hole with a length of 4 mm, for example. For example, top outlet 170 has a transverse size ranging from about 50 mm to about 100 mm in FIG. 1 and almost the same depth as space 200. Fan 130 sucks the air in space 200 via inlet 180, and blows out the air toward pipe 110. Heat exchanger 120 regulates the temperature of the air blown by fan 130 and cools the air, for example. Here, heat exchanger 120 is located at the side to which the air sucked by fan 130 is blown out, and cools the air fed by fan 130. Pipe 110 is connected to the plurality of blowout holes 140 and allows the air whose temperature has been regulated by heat exchanger 120 to pass. Specifically, holes in the side surface of pipe 110 are connected to blowout holes 140, and the cooled air that has passed through pipe 110 is blown out of blowout holes 140. In addition, the cooled air is also blown out of top outlet 170 at the end of pipe 110. The air blown out of top outlet 170 causes a difference in the temperature between the passage of customers, for example, in front of display case 100 (i.e., on the left of display case 100 in FIG. 1) and the cooling section of display case 100. In other words, the air blown out of top outlet 170 severs as a wall to not cause the cool air to leak out to the passage. Note that top outlet 170 will be described below separately from the plurality of blowout holes 140, but may be regarded as one type of blowout holes 140. The air is blown out of top outlet 170 and the plurality of blowout holes 140 to space 200. The air circulates from fan 130 through heat exchanger 120, pipe 110, blowout holes 140 and top outlet 170, space 200, and inlet 180 to fan 130 again to maintain a low temperature in the section including the food. Note that pipe 110 is not necessarily in the shape of a tube but may be any space, such as a space surrounded by a case, for example, as long as allowing the air whose temperature has been regulated by heat exchanger 120 to pass.

There is a need to cool the vicinity of the plurality of shelves 150 in space 200 to be cooled at a constant temperature, and to not cool the passage of customers, for example, in front of display case 100. If the cool air leaks out to the passage, the efficiency in recovering the cool air of fan 130 decreases, which may make the customers uncomfortable. There is thus a need to properly design the capability of fan 130, the capability of heat exchanger 120, the positions and number of the plurality of blowout holes 140, the positions of the plurality of shelves 150, and other characteristics. For proper designing of such characteristics, the temperature distribution in space 200 is simulated, which allows efficient designing.

Customized designing of display case 100 such as a free change in the positions (i.e., heights) of the plurality of shelves 150 is possible. Since the design is changeable in a spot depending on the purpose, analysis of the temperature distribution in space 200 to be cooled is required in a short time after the design change in the spot. While details will be described later, thermal fluid analysis device 1 efficiently analyzes the thermal fluid in this manner.

Next, a configuration of thermal fluid analysis device 1 according to the embodiment will be described with reference to FIG.

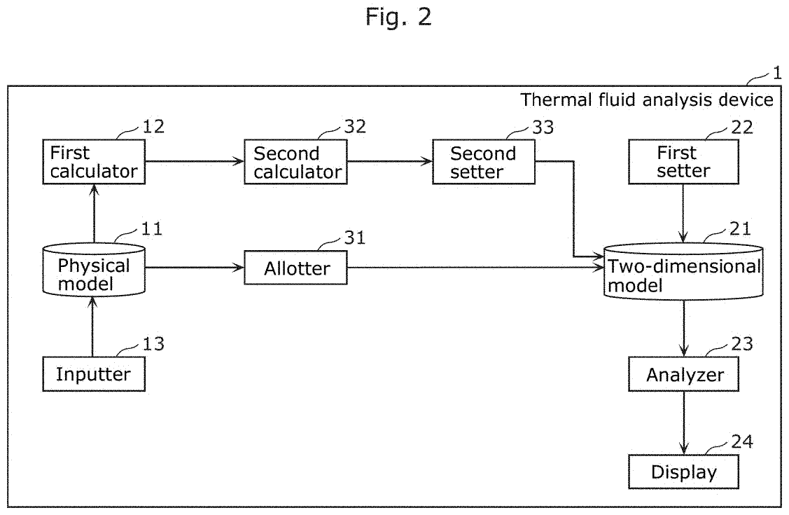

FIG. 2 is a configuration diagram of thermal fluid analysis device 1 according to the embodiment. Thermal fluid analysis device 1 includes physical model 11, first calculator 12, inputter 13, two-dimensional model 21, first setter 22, analyzer 23, display 24, allotter 31, second calculator 32, and second setter 33.

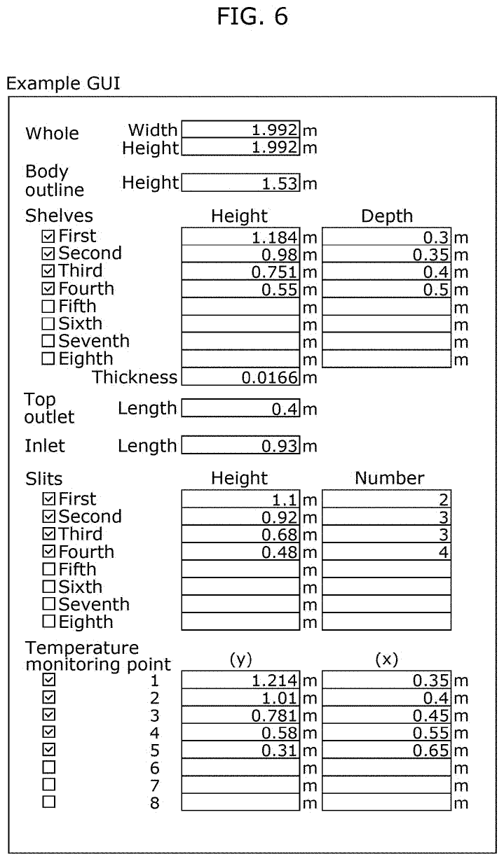

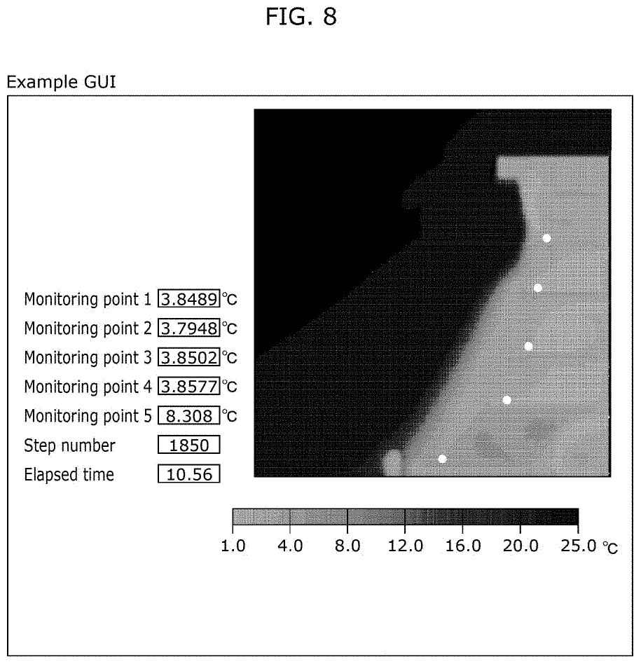

Thermal fluid analysis device 1 is a computer including a processor, a memory, and a user interface, for example. The memory is a ROM or a RAM, for example, capable of storing programs to be executed by the processor. Note that thermal fluid analysis device 1 may include one memory or a plurality of memories. Here, one or more memories are collectively referred to as the “memory”. Physical model 11 and two-dimensional model 21 are stored in the memory. The user interface includes an input device such as a keyboard, a mouse, or a touch panel, and an output device such as a display; and servers as a graphical user interface (GUI). The GUI will be described later with reference to FIGS. 6 and 8. Inputter 13 and display 24 are examples of the user interface. For example, the processor operates in accordance with the programs to operate first calculator 12, first setter 22, analyzer 23, allotter 31, second calculator 32, and second setter 33.

Physical model 11 includes design values related to fan 130, heat exchanger 120, and pipe 110. Heat exchanger 120 regulates the temperature of the air blown by fan 130. Pipe 110 is connected to the plurality of blowout holes 140 and allows the air whose temperature has been regulated by heat exchanger 120 to pass. In addition, physical model 11 includes design values related to top outlet 170 and inlet 180. Physical model 11 is the representation of physical phenomena, such as heat, control, or mechanisms, using physical formulas.

Inputter 13 is a user interface to which the design values described above can be input. Using the design values input to inputter 13, physical model 11 is constructed.

First calculator 12 is a functional constituent element for simulation using physical model 11, and performs simulation using a simulation technique capable of a high-speed calculation called “1D-computer aided engineering (CAE)”, for example. The 1D-CAE is a simulation technique useful in the planning stage of a product requiring immediate obtainment of analysis results. The 1D-CAE is a simulation technique using physical model 11, for example. The 1D-CAE immediately calculates required physical amounts simply by substituting numerical values obtained from physical phenomena such as heat, control, or mechanisms into the physical formulas and thus meets immediacy requirements in designing display case 100 as described above.

However, assume that all the analysis is performed by the 1D-CAE, including the phenomenon that the air with heat itself moves as in the temperature distribution in space 200 to be cooled around display case 100. In this case, a huge number of factors are necessary in the 1D-CAE and may rather fail to meet the immediacy requirements.

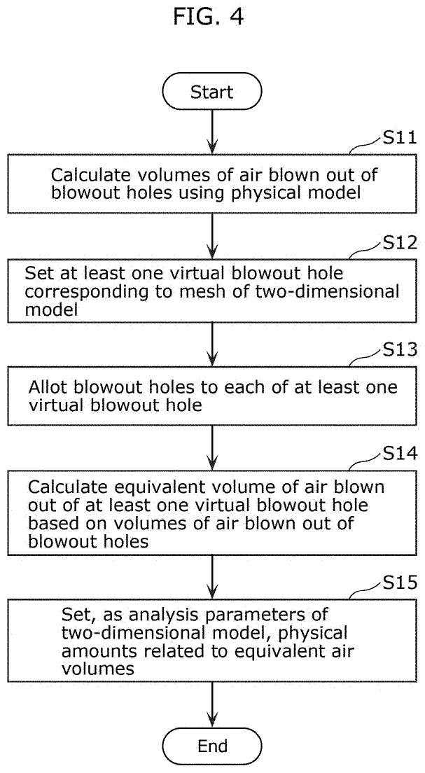

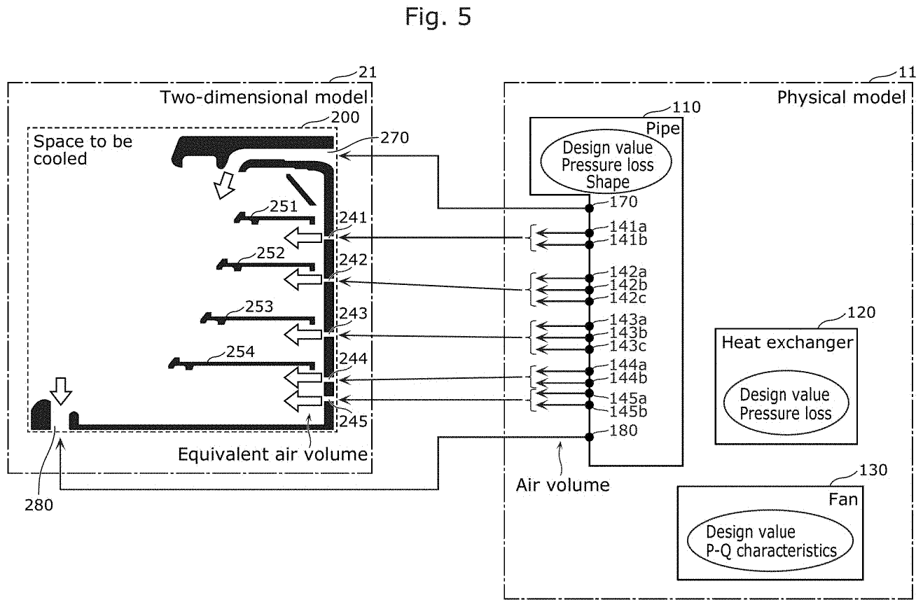

To address the problem, first calculator 12 does not perform simulation of the temperature distribution itself in space 200 to be cooled, which is a weak point of the 1D-CAE. On the other hand, first calculator 12 calculates the volumes of the air blown out of the plurality of blowout holes 140 using physical model 11. In addition, first calculator 12 calculates the volume of the air blown out of top outlet 170 and the volume of the air sucked into inlet 180 using physical model 11. The detailed operation of first calculator 12 will be described later with reference to FIGS. 4 and 5.

Two-dimensional model 21 is obtained by dividing a certain two-dimensional space into a plurality of finite number of elements (i.e., meshes). For example, space 200 to be cooled can be represented by meshes of two-dimensional model 21 as shown in FIG.

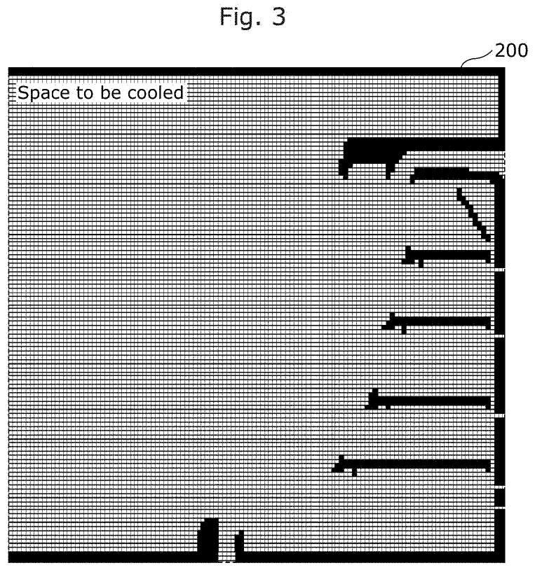

FIG. 3 shows an example of space 200 to be cooled represented by two-dimensional model 21 according to the embodiment. For example, each mesh is in a 16 mm square, and the number of the meshes is 96×96. Note that the size, shape, and number of the meshes are not limited thereto and may be set as appropriate in accordance with a target space, for example.

First setter 22 is a functional constituent element for setting at least one virtual blowout hole corresponding to a mesh of two-dimensional model 21 of space 200 to be cooled. In addition, first setter 22 sets a virtual top outlet and a virtual inlet corresponding to the meshes of two-dimensional model 21 of space 200. Note that the virtual top outlet may be one type of the virtual blowout holes. The detailed operation of first setter 22 will be described later with reference to FIGS. 4 and 5.

Analyzer 23 is a functional constituent element for simulation using two-dimensional model 21 and performs simulation using CAE by a finite difference method (referred to as “2D-CAE”), for example. The 2D-CAE allows analysis of the phenomenon that the air with heat itself moves as in the temperature distribution in space 200 to be cooled around display case 100 in a shorter time than the 1D-CAE. It is known that the behavior of a thermal fluid can be expressed by the Navier-Stokes equation (i.e., following Equation 1) and the continuity equation (i.e., following Equation 2). In the 2D-CAE, the solutions of the equations are obtained.

$$\begin{matrix}[ Math . 1 ] & \\ \frac{\partial v}{\partial t} + ( v \cdot ∇ ) v = - \frac{1}{ρ} ∇ p + v Δ - g \hat{z} & ( 1 ) \\ [ Math . 2 ] & \\ ∇ \cdot v = 0 & ( 2 )\end{matrix}$$

Here, v is the velocity vector, p is the pressure, ρ is the air density, and g is the gravity.

Display 24 is a user interface capable of displaying the results of analysis by analyzer 23. For example, the window, menu, icons, checkboxes, or value input boxes of the GUI may be displayed on display 24.

Allotter 31 allots one or more blowout holes 140 out of the plurality of blowout holes 140 to each of the at least one virtual blowout hole set by first setter 22. In addition, allotter 31 allots top outlet 170 to the virtual top outlet, and inlet 180 to the virtual inlet.

Second calculator 32 calculates the equivalent volume of the air blown out of the at least one virtual blowout hole based on the volumes of the air blown out of the one or more blowout holes 140. In addition, second calculator 32 calculates the equivalent volume of the air blown out of the virtual top outlet based on the volume of the air blown out of top outlet 170, and the equivalent volume of the air sucked into the virtual inlet based on the volume of the air sucked into inlet 180.

Second setter 33 sets, as the analysis parameters of two-dimensional model 21, the physical amounts related to the equivalent air volumes calculated by second calculator 32.

Allotter 31, second calculator 32, and second setter 33 are functional constituent elements for converting the analysis parameters of physical model 11 into the analysis parameters of two-dimensional model 21 to analyze the temperature distribution in space 200 to be cooled using two-dimensional model 21. The detailed operations of allotter 31, second calculator 32, and second setter 33 will be described with reference to FIGS. 4 and 5.

Next, an operation of thermal fluid analysis device 1 will be described with reference to FIGS. 4 and 5.

FIG. 4 is a flowchart showing an example of the operation of thermal fluid analysis device 1 according to the embodiment.

FIG. 5 illustrates the detailed operation of thermal fluid analysis device 1 according to the embodiment. In FIG. 5, the right is a conceptual diagram of physical model 11, whereas the left is a conceptual diagram of two-dimensional model 21.

First, first calculator 12 calculates the volumes of the air blown out of the plurality of blowout holes 140 using physical model 11 (step S11). The volumes of the air blown out of the plurality of blowout holes 140 change in accordance with the pressure difference (P-Q characteristics) in front of and behind fan 130 as the design value of fan 130, the pressure loss of heat exchanger 120 as the design value of heat exchanger 120, and the pressure loss and shape of pipe 110 as well as the size, positions, and number of the plurality of blowout holes 140 as the design values of pipe 110. In other words, the physical phenomenon of the volumes of the air blown out of the plurality of blowout holes 140 can be expressed by a physical formula using these design values as variables. Physical model 11 is a physical formula including these design values. That is, first calculator 12 easily calculates the volumes of the air blown out of the plurality of blowout holes 140 based on these design values. Similarly, first calculator 12 easily calculates the volume of the air blown out of top outlet 170 and the volume of the air sucked into inlet 180.

Next, first setter 22 sets at least one virtual blowout hole corresponding to a mesh of two-dimensional model 21 of space 200 to be cooled (step S12). First setter 22 sets, as the at least one virtual blowout hole, a mesh on two-dimensional model 21 corresponding to the positions of the plurality of blowout holes 140 open in display case 100. Note that “first setter 22 sets at least one virtual blowout hole” means that first setter 22 obtains the information indicating the at least one virtual blowout hole. Similarly, first setter 22 sets, as a virtual top outlet, the mesh on two-dimensional model 21 corresponding to the position of top outlet 170 open in display case 100. First setter 22 sets, as a virtual inlet, the mesh on two-dimensional model 21 corresponding to the position of inlet 180. As shown in FIG. 5, first setter 22 sets, as a plurality of virtual blowout holes 241, 242, 243, 244 and 245, virtual top outlet 270, and virtual inlet 280, specific meshes on two-dimensional model 21, for example. Alternatively or additionally, for example, the at least one virtual blowout hole is set in accordance with the area defined by a partition (i.e., shelf 150) in space 200. In two-dimensional model 21, the plurality of shelves 150 are expressed by virtual shelves 251, 252, 253, and 254. The meshes on two-dimensional model 21 corresponding to the areas defined by the plurality of shelves 150 are: the mesh between virtual shelves 251 and 252, the mesh between virtual shelves 252 and 253, the mesh between virtual shelves 253 and 254, and the mesh between virtual shelf 254 and a virtual bottom corresponding to the bottom of the food display section of the display case. These meshes on two-dimensional model 21 are set as the plurality of virtual blowout holes 241, 242, 243, 244, and 245.

Next, allotter 31 allots one or more blowout holes 140 out of the plurality of blowout holes 140 to each of the at least one virtual blowout hole (step S13). Specifically, allotter 31 allots two or more blowout holes 140 out of the plurality of blowout holes 140 to each of the at least one virtual blowout hole. Similarly, allotter 31 allots top outlet 170 to virtual top outlet 270, and inlet 180 to virtual inlet 280.

As shown in FIG. 5, for example, display case 100 includes, as the plurality of blowout holes 140, blowout holes 141a, 141b, 142a, 142b, 142c, 143a, 143b, 143c, 144a, 144b, 145a, and 145b. Blowout holes 141a and 141b are located close to each other (e.g., at a distance of 1 mm to 2 mm). Blowout holes 142a, 142b, and 142c, blowout holes 143a, 143b, and 143c, blowout holes 144a and 144b, and blowout holes 145a and 145b are also located close to each other. Allotter 31 allots two blowout holes 141a and 141b out of the plurality of blowout holes 140 to one virtual blowout hole 241. Similarly, allotter 31 allots three blowout holes 142a, 142b, and 142c to one virtual blowout hole 242, three blowout holes 143a, 143b, and 143c to one virtual blowout hole 243, two blowout holes 144a and 144b to one virtual blowout hole 244, and two blowout holes 145a and 145b to one virtual blowout hole 245.

Note that one blowout hole 140 may be allotted to one virtual blowout hole. However, for example, in this embodiment, each blowout hole 140 has a length of 4 mm, whereas each mesh is in a 16 mm square. If one blowout hole 140 is allotted to one virtual blowout hole, there is a need to reduce the size of the meshes around the positions on two-dimensional model 21 corresponding to the plurality of blowout holes 140 into, for example, about a 4 mm square. It takes more time to design two-dimensional model 21 with the meshes in a complicated design or a smaller size, and to perform calculation using such two-dimensional model 21. On the other hand, for example, two or three close blowout holes 140 are open in display case 100 within the range of the 16 mm square, which is the mesh size, for example. Two or three close blowout holes 140 are collectively regarded to as one virtual blowout hole on two-dimensional model 21. This reduces the times for designing two-dimensional model 21 and calculation using two-dimensional model 21. Note that all of four blowout holes 144a, 144b, 145a, and 145b do not fall within the range of the 16 mm square which is the mesh size. Here, blowout holes 144a and 144b are allotted to one virtual blowout hole 244, and blowout holes 145a and 145b are allotted to one virtual blowout hole 245. Note that one blowout hole 140 may be allotted to one virtual blowout hole.

Next, second calculator 32 calculates the equivalent volume of the air blown out of the at least one virtual blowout hole (i.e., virtual blowout hole 241 to 245 here) based on the volumes of the air blown out of the one or more blowout holes 140 calculated by first calculator 12 (step S14). For example, virtual blowout hole 241 will be focused on. Second calculator 32 calculates the equivalent volume of the air blown out of virtual blowout hole 241 based on the volumes of the air blown out of blowout holes 141a and 141b allotted to virtual blowout hole 241. Specifically, second calculator 32 calculates the sum of the volumes of the air blown out of blowout hole 141a and the air blown out of blowout hole 141b as the equivalent volume of the air blown out of virtual blowout hole 241. Note that how to calculate the equivalent air volume is not limited to the calculation method through such the simple addition and may be selected as appropriate in accordance with the situation. Similarly, the equivalent volumes of the air blown out of the other virtual blowout holes 242 to 245 are calculated based on the volumes of the air blown out of respective blowout holes 140 allotted to virtual blowout holes 242 to 245. Similarly, the equivalent volume of the air blown out of virtual top outlet 270 is calculated based on the volume of the air blown out of top outlet 170. The equivalent volume of the air sucked into virtual inlet 280 is calculated based on the volume of the air sucked into inlet 180.

Then, second setter 33 sets, as the analysis parameters of two-dimensional model 21, the physical amounts related to the equivalent air volumes calculated by second calculator 32 (step S15). Specifically, second setter 33 outputs the physical amounts related to the equivalent air volumes calculated by second calculator 32 to two-dimensional model 21. Accordingly, the following is possible without forming virtual constituent elements corresponding to pipe 110, heat exchanger 120, fan 130, and other elements on two-dimensional model 21. The volumes of the air blown out of the plurality of blowout holes 140, blown out of top outlet 170, and, sucked into inlet 180 using pipe 110, heat exchanger 120, and fan 130 can be reproduced on two-dimensional model 21. That is, there is no need to create two-dimensional model 21 for all the parts related to the thermal designing of the product. Two-dimensional model 21 needs to be created for space 200 to be cooled only. The equivalent air volumes calculated using physical model 11 only need to correspond to the virtual blowout holes (i.e., the meshes), for example, on two-dimensional model 21.

In this manner, thermal fluid analysis device 1 converts the analysis parameters of physical model 11 into the analysis parameters of two-dimensional model 21 and thus efficiently analyzes a thermal fluid.

Next, a GUI for simulation using thermal fluid analysis device 1 will be described with reference to FIGS. 6 and 8.

FIGS. 6 and 8 show examples of the GUI of thermal fluid analysis device 1 according to the embodiment.

FIG. 6 shows a screen to which the positions and number of blowout holes 140, the positions and sizes of shelves 150, and the positions for monitoring the temperature distribution in space 200 to be cooled, for example, are input.

For example, using the checkboxes in the section “shelves” on the screen, a desired number of shelves 150 can be set in display case 100. By inputting numerical values to the value input boxes “height” and “depth” in this section, shelves 150 can be provided in desired positions and sizes in display case 100. That is, the temperature distribution in space 200 to be cooled can be analyzed when variously changing the conditions such as the number, positions, and sizes of shelves 150.

For example, the checkboxes in the section “slits” on the screen are basically checked in accordance with the checkboxes in the section “shelves”. Here, the first of the section “slits” will be focused on. For example, the first checkbox of the checkboxes in the section “shelves” corresponds to the first checkbox of the checkboxes in the section “slits”. On the screen, the first value input box of the “slits” is for inputting the positions and number of blowout holes 140 open between shelf 150 corresponding to the first “shelf” and shelf 150 corresponding to the second “shelf”. For example, in accordance with the positions of shelf 150 corresponding to the first “shelf” and shelf 150 corresponding to the second “shelf”, the upper limit of the value inputtable to the first value input box of the “slits” is determined.

For example, using the checkboxes in the section “temperature monitoring points” on the screen, a desired number of the monitoring points can be set in the temperature distribution in space 200 to be cooled. By inputting numerical values to the value input boxes “(y)” and “(x)” in this section, where in space 200 is to be monitored can be set.

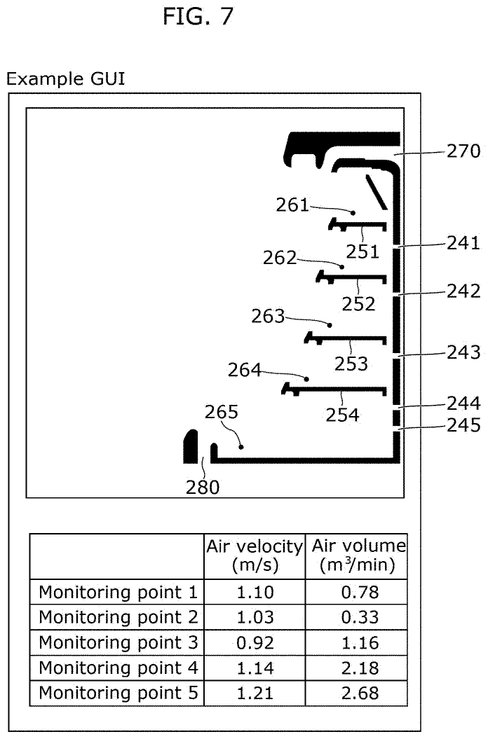

By inputting the numerical values, for example, to the screen, virtual space 200 to be cooled is, for example, drawn on two-dimensional model 21 automatically and displayed as shown in FIG. 7.

FIG. 7 shows a screen showing virtual space 200 created on two-dimensional model 21 by inputting numerical values, for example, to the screen shown in FIG. 6, for example.

By inputting numerical values to the first to fourth of the “selves” set in FIG. 6, virtual shelves 251 to 254 are created on two-dimensional model 21. In addition, by inputting numerical values to the first to fourth of the “slits” set in FIG. 6, virtual blowout hole 241 to 245 are created on two-dimensional model 21. For example, in accordance with the input of “4” into the value input box “number” of the fourth of the “slits” in FIG. 6, two virtual blowout holes 244 and 245 are created on two-dimensional model 21. The reason follows. Based on a predetermined size of the meshes of two-dimensional model 21 and a predetermined size of blowout holes 140 of display case 100, the number of blowout holes 140 to be allotted to one virtual blowout hole (i.e., mesh) is determined. It is determined that four blowout holes 140 cannot be allotted to one virtual blowout hole. For example, such determination is made automatically. That is, simply by inputting a desired number for blowout holes 140 on the screen shown in FIG. 6, the virtual blowout holes corresponding to the input number of blowout holes 140 such as two virtual blowout holes 244 and 245 are created separately and automatically on two-dimensional model 21. By inputting a numerical value to the “length” of the “top outlet” set in FIG. 6, virtual top outlet 270 is created on two-dimensional model 21. By inputting a numerical value to the “length” of the “inlet” set in FIG. 6, virtual inlet 280 is created on two-dimensional model 21.

Assume that a numerical value input to the screen shown in FIG. 6 is changed. In this case, the shape on two-dimensional model 21 on the screen shown in FIG. 7 changes automatically in accordance with the input numerical value. Accordingly, even a designer without knowledge specialized in simulation easily updates two-dimensional model 21 by inputting numerical values to such a GUI.

In virtual space 200 to be cooled, points 261 to 265 are shown as temperature monitoring points 1 to 5 set in FIG. 6. The air velocities and air volumes in these points are displayed at the bottom of the screen.

With the start of the analysis, the temperature distribution in space 200 to be cooled is displayed as shown in FIG. 8.

FIG. 8 shows a screen showing the temperature distribution in space 200 to be cooled, and displays changes in the temperatures of mesh points over time.

For example, two-dimensional model 21 is an unsteady analysis model. Analyzer 23 calculates the difference in the physical amounts related to the analysis results between time steps. When the calculated difference becomes smaller than or equal to a predetermined value, analyzer 23 ends the analysis. Specifically, when the temperature of a specific mesh or the average temperature of a plurality of meshes stop changing at the elapse of a certain time, the analysis ends. Note that a designer may monitor the screen shown in FIG. 8 and manually end the analysis upon obtaining a satisfactory result, for example. Alternatively, the analysis may automatically end at the elapse of a certain time.

Note that the screens shown in FIGS. 6 and 8 may be arranged and displayed as one screen. The display as one screen allows the designer to check, while checking input numerical values, the shape on two-dimensional model 21 changing in accordance with the numerical values or the analysis results at that time.

Note that the present invention can be implemented not only as thermal fluid analysis device 1 but also a thermal fluid analysis method including steps (i.e., processing) performed by the constituent elements of thermal fluid analysis device 1.

Specifically, the thermal fluid analysis method is a method of analyzing at least one of the temperature distribution or the velocity distribution in the space (space 200 to be cooled) to which air is blown out of the plurality of blowout holes 140, using two-dimensional model 21 or a three-dimensional model. As shown in FIG. 4, the thermal fluid analysis method includes: calculating the volumes of the air blown out of the plurality of blowout holes 140, using physical model 11 including the design values related to fan 130, heat exchanger 120, and pipe 110. Heat exchanger 120 regulates the temperature of the air blown by fan 130. Pipe 110 is connected to the plurality of blowout holes 140 and allows the air whose temperature has been regulated by heat exchanger 120 to pass (step S11); setting at least one virtual blowout hole corresponding to a mesh of two-dimensional model 21 or the three-dimensional model of space 200 (step S12); allotting one or more blowout holes out of the plurality of blowout holes 140 to each of the at least one virtual blowout hole (step S13); calculating the equivalent volume of the air blown out of the at least one virtual blowout hole based on the volumes of the air blown out of the one or more blowout holes 140 (step S14); and setting, as the analysis parameters of two-dimensional model 21 or the three-dimensional model, the physical amounts related to the equivalent air volume (step S15).

In order to analyze at least one of the temperature distribution or the velocity distribution in a space (e.g., space 200 to be cooled), the volumes of the air blown out of the plurality of blowout holes 140 to space 200 needs to be calculated. With respect to the air volumes, none of two-dimensional model 21 or the three-dimensional model but physical model 11 is used which represents physical phenomena using physical formulas. Using physical model 11, the air volumes can be obtained through simple calculation such as substitution of numerical values to physical formulas, the air volumes can be calculated in only a short time. In addition, one or more blowout holes 140 are allotted to a virtual blowout hole. The equivalent air volume is calculated based on the air volumes described above. The physical amounts related to the equivalent air volume are set as the analysis parameters of two-dimensional model 21 or the three-dimensional model. Accordingly, the analysis parameters of physical model 11 are converted into the analysis parameters of two-dimensional model 21 or the three-dimensional model. There is thus no need to create two-dimensional model 21 or the three-dimensional model for any of fan 130, heat exchanger 120, or pipe 110 for thermal fluid analysis. This reduces the time for designing two-dimensional model 21 or the three-dimensional model and for calculation using two-dimensional model 21 or the three-dimensional model. For example, one-tenth of time was required as compared to the designing and calculation of the whole space including fan 130, heat exchanger 120, and pipe 110 using a three-dimensional model (more specifically, the require time was shortened from 820 minutes to 33 minutes). In this manner, the thermal fluid can be efficiently analyzed, which reduces the number of tests and steps, for example, and eventually reduces the costs.

In the allotment (step S13), two or more blowout holes 140 out of the plurality of blowout holes 140 may be allotted to each of the at least one virtual blowout hole.

For example, assume that one blowout hole 140 is allotted to one virtual blowout hole. In this case, there is a need to set the sizes of the meshes around the positions corresponding to the plurality of blowout holes 140 on two-dimensional model 21 or the three-dimensional model in detail. It takes more time for designing two-dimensional model 21 or the three-dimensional model with the meshes in a more complicated design or a smaller size, and for calculation using such two-dimensional model 21 or the three-dimensional model. To address the problems, two or more blowout holes 140 are allotted to one virtual blowout hole, which allows more efficient thermal fluid analysis in a shorter time.

The at least one virtual blowout hole may be set in accordance with an area defined by a partition (i.e., shelf 150) in space 200 to be cooled.

Accordingly, the conditions of simulation become closer to the actual state. At least one of the temperature distribution or the velocity distribution can be analyzed at a higher accuracy.

Two-dimensional model 21 or the three-dimensional model is an unsteady analysis model. The thermal fluid analysis method may further include: calculating the difference in the physical amounts related to the analysis results between time steps; and ending the analysis when the calculated difference becomes smaller than or equal to a predetermined value.

Accordingly, the analysis automatically ends when the executed simulation becomes steady, which improves the convenience of a designer.

Thermal fluid analysis device 1 analyzes at least one of the temperature distribution or the velocity distribution in the space (space 200 to be cooled) to which air is blown out of the plurality of blowout holes 140 using two-dimensional model 21 or a three-dimensional model. Thermal fluid analysis device 1 includes: first calculator 12, first setter 22, allotter 31, second calculator 32, and second setter 33. First calculator 12 calculates the volumes of the air blown out of the plurality of blowout holes 140 using physical model 11 including the design values related to fan 130, heat exchanger 120, and pipe 110. Heat exchanger 120 regulates the temperature of the air blown by fan 130. Pipe 110 is connected to the plurality of blowout holes 140 and allows the air whose temperature has been regulated by heat exchanger 120 to pass. First setter 22 sets the at least one virtual blowout hole corresponding to a mesh of two-dimensional model 21 or the three-dimensional model of space 200. Allotter 31 allots one or more blowout holes out of the plurality of blowout holes 140 to each of the at least one virtual blowout hole. Second calculator 32 calculates the equivalent volume of the air blown out of the at least one virtual blowout hole based on the volumes of the air blown out of the one or more blowout holes 140. Second setter 33 sets, as the analysis parameters of two-dimensional model 21 or the three-dimensional model, physical amounts related to the equivalent air volume.

Accordingly, thermal fluid analysis device 1 is provided which efficiently analyzes a thermal fluid.

### OTHER EMBODIMENTS

While the thermal fluid analysis method and thermal fluid analysis device 1 according to the embodiment have been described above, the present invention is not limited to the embodiment described above.

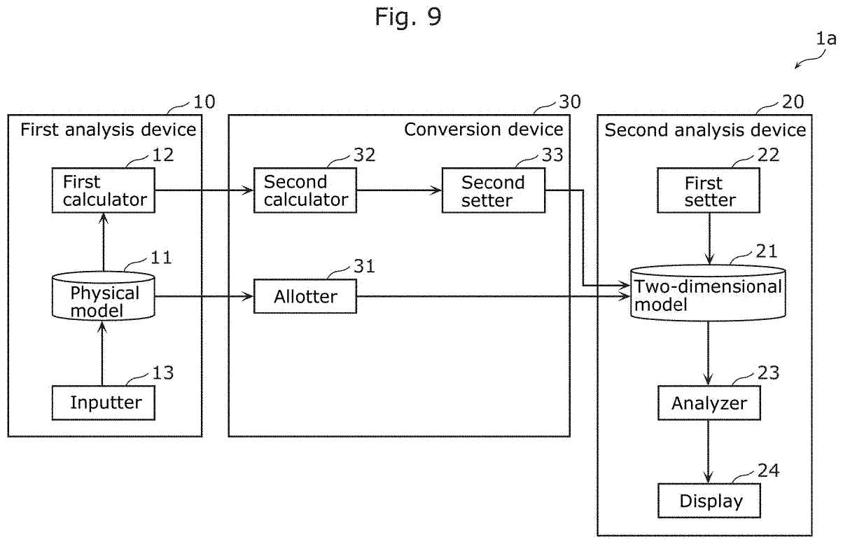

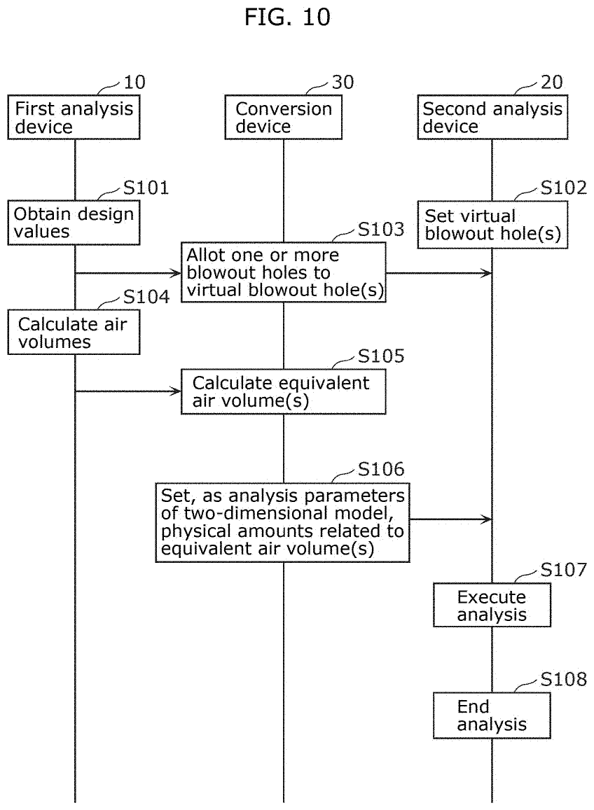

For example, in the embodiment described above, physical model 11, first calculator 12, inputter 13, two-dimensional model 21, first setter 22, analyzer 23, display 24, allotter 31, second calculator 32, and second setter 33 are located in one thermal fluid analysis device 1. The locations are not limited thereto. These elements may be distributed into a plurality of different devices. This will be described with reference to FIGS. 9 and 10.

FIG. 9 is a configuration diagram of thermal fluid analysis system 1a according to another embodiment.

Thermal fluid analysis system 1a includes first analysis device 10, second analysis device 20, and conversion device 30. In thermal fluid analysis system 1a, physical model 11, first calculator 12, and inputter 13 of thermal fluid analysis device 1 are located in first analysis device 10. Two-dimensional model 21, first setter 22, analyzer 23, and display 24 are located in second analysis device 20. Allotter 31, second calculator 32, and second setter 33 are located in conversion device 30.

First analysis device 10 is for simulation using physical model 11, whereas second analysis device 20 is for simulation using two-dimensional model 21. Conversion device 30 is for converting the analysis parameters of physical model 11 into the analysis parameters of two-dimensional model 21 so as to analyze the temperature distribution in space 200 to be cooled, using two-dimensional model 21. In this manner, the constituent elements of thermal fluid analysis device 1 may be distributed into a plurality of devices.

FIG. 10 is a sequence diagram showing an example of the operation of thermal fluid analysis system 1a according to the other embodiment. The operation is basically the same as the operation of thermal fluid analysis device 1. Overlapping the operation of thermal fluid analysis device 1, the operation of thermal fluid analysis system 1a will be described briefly.

First analysis device 10 obtains the design values related to fan 130, heat exchanger 120, and pipe 110 (step S101). For example, the design values are input to inputter 13, whereby first analysis device 10 obtains the design values.

Second analysis device 20 sets at least one virtual blowout hole corresponding to a mesh of two-dimensional model 21 of space 200 to be cooled (step S102).

Conversion device 30 allots one or more blowout holes 140 out of the plurality of blowout holes 140 included in the design values obtained by first analysis device 10 to each of the at least one virtual blowout hole set by second analysis device 20 (step S103).

First analysis device 10 calculates the volumes of the air blown out of the plurality of blowout holes 140 using physical model 11 including the obtained design values (step S104).

Conversion device 30 calculates the equivalent volume of the air blown out of the at least one virtual blowout hole based on the volumes of the air blown out of the one or more blowout holes 140 calculated by first analysis device 10 (step S105).

Conversion device 30 sets, as the analysis parameters of two-dimensional model 21, physical amounts related to the calculated equivalent air volume (step S106).

Second analysis device 20 causes conversion device 30 to execute the analysis using two-dimensional model 21 in which the physical amounts related to the equivalent air volume described above are set as the analysis parameters (step S107).

Then, second analysis device 20 calculates the difference in the physical amounts related to the analysis results between time steps, for example. When the calculated difference becomes smaller than or equal to a predetermined value, second analysis device 20 ends the analysis (step S108).

Conversion device 30 includes characteristic constituent elements for converting the analysis parameters of physical model 11 into the analysis parameters of two-dimensional model 21 or the three-dimensional model. The present invention can thus be implemented not only as thermal fluid analysis device 1 but also as conversion device 30 and further as a conversion method including steps (i.e., processing) performed by the constituent elements of conversion device 30.

Specifically, the conversion method is a method of converting the analysis parameters of physical model 11 including the design values related to fan 130, heat exchanger 120, and pipe 110 into the analysis parameters of two-dimensional model 21 or the three-dimensional model to analyze at least one of the temperature distribution or the velocity distribution in the space (space 200 to be cooled) to which air is blown out of the plurality of blowout holes 140, using two-dimensional model 21 or a three-dimensional model. Heat exchanger 120 regulates the temperature of the air blown by fan 130. Pipe 110 is connected to the plurality of blowout holes 140 and allows the air whose temperature has been regulated by heat exchanger 120 to pass. As shown in FIG. 4, in the conversion method, one or more blowout holes out of the plurality of blowout holes 140 are allotted to each of the at least one virtual blowout hole corresponding to a mesh of two-dimensional model 21 or the three-dimensional model of space 200 (step S13). The equivalent volume of the air blown out of the at least one virtual blowout hole is calculated based on the volumes of the air blown out of the one or more blowout holes 140 calculated using physical model 11 (step S14). The physical amounts related to the equivalent air volume are set, as the analysis parameters of two-dimensional model 21 or the three-dimensional model (step S15).

Accordingly, the conversion method is provided which allows efficient analysis of a thermal fluid.

Conversion device 30 converts the analysis parameters of physical model 11 including the design values related to fan 130, heat exchanger 120, and pipe 110 into the analysis parameters of two-dimensional model 21 or the three-dimensional model to analyze at least one of the temperature distribution or the velocity distribution in the space (space 200 to be cooled) to which air is blown out of the plurality of blowout holes 140, using two-dimensional model 21 or a three-dimensional model. Heat exchanger 120 regulates the temperature of the air blown by fan 130. Pipe 110 is connected to the plurality of blowout holes 140 and allows the air whose temperature has been regulated by heat exchanger 120 to pass. Conversion device 30 includes allotter 31, a calculator (i.e., second calculator 32), and a setter (i.e., second setter 33). Allotter 31 allots one or more blowout holes 140 out of the plurality of blowout holes 140 to each of the at least one virtual blowout hole corresponding to a mesh of two-dimensional model 21 or the three-dimensional model of space 200. The calculator calculates the equivalent volume of the air blown out of the at least one virtual blowout hole based on the volumes of the air blown out of the one or more blowout holes 140 calculated using physical model 11. The setter sets, as the analysis parameters of two-dimensional model 21 or the three-dimensional model, the physical amounts related to the equivalent air volume.

Accordingly, conversion device 30 is provided which efficiently analyzes a thermal fluid.

For example, the steps of the thermal fluid analysis method and the conversion method may be executed by a computer (or a computer system). The present invention may be implemented as a program for causing a computer to execute the steps included in these methods. In addition, the present invention may be implemented as a non-transitory computer-readable recording medium, such as a CD-ROM, storing the program. Note that the recording medium is not necessarily non-transitory.

For example, if the present invention is implemented as a program (software), the program is executed utilizing hardware resources such as a CPU, a memory, and an input and output circuit of a computer to execute the steps. Specifically, the CPU obtains data from the memory or the input and output circuit, for example, for calculation, or outputs calculation results to the memory or the input and output circuit, for example, to execute the steps.

The constituent elements included in thermal fluid analysis device 1 and conversion device 30 according to the embodiments described above may be dedicated circuits or general-purpose circuits.

The constituent elements included in thermal fluid analysis device 1 and conversion device 30 according to the embodiments described above may be large scale integration (LSI) devices that are integrated circuits (ICs).

The circuit integration is not limited to the LSI. The devices may be dedicated circuits or general-purpose processors. A field programmable gate array (FPGA) programmable or a reconfigurable processor capable of reconfiguring the connections and settings of circuit cells inside an LSI may be employed.

Appearing as an alternative circuit integration technology to the LSI, another technology that progresses or deprives from the semiconductor technology may be clearly used for circuit integration of the constituent elements included in thermal fluid analysis device 1 and conversion device 30.

The present invention includes other embodiments, such as those obtained by variously modifying the embodiments as conceived by those skilled in the art or those achieved by freely combining the constituent elements and functions in the embodiments without departing from the scope and spirit of the present invention.

### REFERENCE SIGNS LIST

1 thermal fluid analysis device
1a thermal fluid analysis system
10 first analysis device
11 physical model
12 first calculator
13 inputter
20 second analysis device
21 two-dimensional model
22 first setter
23 analyzer
24 display
30 conversion device
31 allotter
32 second calculator (calculator)
33 second setter (setter)
100 display case
110 pipe
120 heat exchanger
130 fan
140, 141a, 141b, 142a, 142b, 142c, 143a, 143b, 143c, 144a, 144b, 145a, 145b blowout hole
150 shelf
170 top outlet
180 inlet
200 space to be cooled (space)
241, 242, 243, 244, 245 virtual blowout hole
251, 252, 253, 254 virtual shelf
261, 262, 263, 264, 265 point
270 virtual top outlet
280 virtual inlet

1. A thermal fluid analysis method of analyzing at least one of a temperature distribution or a velocity distribution in a space to which air is blown out of a plurality of blowout holes, using a two-dimensional model or a three-dimensional model, the thermal fluid analysis method comprising:
calculating volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass;
setting at least one virtual blowout hole corresponding to a mesh of the two-dimensional model or the three-dimensional model of the space;
allotting one or more blowout holes out of the plurality of blowout holes to each of the at least one virtual blowout hole;
calculating an equivalent volume of air blown out of the at least one virtual blowout hole based on the volumes of the air blown out of the one or more blowout holes; and
setting, as an analysis parameter of the two-dimensional model or the three-dimensional model, a physical amount related to the equivalent volume.

2. The thermal fluid analysis method according to claim 1, wherein
in the allotting, two or more blowout holes out of the plurality of blowout holes are allotted to each of the at least one virtual blowout hole.

3. The thermal fluid analysis method according to claim 1, wherein
the at least one virtual blowout hole is set in accordance with an area defined by a partition in the space.

4. The thermal fluid analysis method according to claim 1, wherein
the two-dimensional model or the three-dimensional model is an unsteady analysis model,
the thermal fluid analysis method further includes:
calculating a difference in a physical amount related to an analysis result between time steps; and
ending analysis, when the difference calculated becomes smaller than or equal to a predetermined value.

5. A non-transitory computer-readable recording medium storing a program for causing a computer to execute the thermal fluid analysis method according to claim 1.

6. A thermal fluid analysis device for analyzing at least one of a temperature distribution or a velocity distribution in a space to which air is blown out of a plurality of blowout holes, using a two-dimensional model or a three-dimensional model, the thermal fluid analysis device comprising:
a first calculator that calculates volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass;
a first setter that sets at least one virtual blowout hole corresponding to a mesh of the two-dimensional model or the three-dimensional model of the space;
an allotter that allots one or more blowout holes out of the plurality of blowout holes to each of the at least one virtual blowout hole;
a second calculator that calculates an equivalent volume of air blown out of the at least one virtual blowout hole based on the volumes of the air blown out of the one or more blowout holes; and
a second setter that sets, as an analysis parameter of the two-dimensional model or the three-dimensional model, a physical amount related to the equivalent volume.

7. A conversion method of converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass, the conversion method comprising:
allotting one or more blowout holes out of the plurality of blowout holes to each of at least one virtual blowout hole corresponding to a mesh of the two-dimensional model or the three-dimensional model of the space;
calculating an equivalent volume of air blown out of the at least one virtual blowout hole based on volumes of the air blown out of the one or more blowout holes calculated using the physical model; and
setting, as the analysis parameter of the two-dimensional model or the three-dimensional model, a physical amount related to the equivalent volume.

8. A non-transitory computer-readable recording medium storing a program for causing a computer to execute the conversion method according to claim 7.

9. A conversion device for converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass, the conversion device comprising:
an allotter that allots one or more blowout holes out of the plurality of blowout holes to each of at least one virtual blowout hole corresponding to a mesh of the two-dimensional model or the three-dimensional model of the space;
a calculator that calculates an equivalent volume of air blown out of the at least one virtual blowout hole based on volumes of the air blown out of the one or more blowout holes calculated using the physical model; and
a setter that sets, as the analysis parameter of the two-dimensional model or the three-dimensional model, a physical amount related to the equivalent volume.

10. A thermal fluid analysis device for analyzing at least one of a temperature distribution or a velocity distribution in a space to which air is blown out of a plurality of blowout holes, using a two-dimensional model or a three-dimensional model, the thermal fluid analysis device comprising:
a processor; and
a memory, wherein
using the memory, the processor:
calculates volumes of the air blown out of the plurality of blowout holes using a physical model including design values related to a fan, a heat exchanger, and a pipe, the heat exchanger regulating a temperature of air blown by the fan, the pipe being connected to the plurality of blowout holes and allowing the air whose temperature has been regulated by the heat exchanger to pass;
sets at least one virtual blowout hole corresponding to a mesh of the two-dimensional model or the three-dimensional model of the space;
allots one or more blowout holes out of the plurality of blowout holes to each of the at least one virtual blowout hole;
calculates an equivalent volume of air blown out of the at least one virtual blowout hole based on the volumes of the air blown out of the one or more blowout holes; and
sets, as an analysis parameter of the two-dimensional model or the three-dimensional model, a physical amount related to the equivalent volume.

11. A conversion device for converting an analysis parameter of a physical model including design values related to a fan, a heat exchanger, and a pipe into an analysis parameter of a two-dimensional model or a three-dimensional model to analyze at least one of a temperature distribution or a velocity distribution in a space to which air is blown out of a plurality of blowout holes, using the two-dimensional model or the three-dimensional model, the heat exchanger regulating a temperature of air blown by the fan, the pipe being connected to the plurality of blowout holes and allowing the air whose temperature has been regulated by the heat exchanger to pass, the conversion device comprising:
a processor; and
a memory, wherein
using the memory, the processor:
allots one or more blowout holes out of the plurality of blowout holes to each of at least one virtual blowout hole corresponding to a mesh of the two-dimensional model or the three-dimensional model of the space;
calculates an equivalent volume of air blown out of the at least one virtual blowout hole based on volumes of the air blown out of the one or more blowout holes calculated using the physical model; and
sets, as the analysis parameter of the two-dimensional model or the three-dimensional model, a physical amount related to the equivalent volume.
